(19) United States
(12) Patent Application Publication
(10) Pub. No.: US 2017/0067860 A1
(43) Pub. Date: Mar. 9, 2017

(54) Control Area Network Machine Diagostic

(71) Applicants: Paul Grabill, Poway, CA (US); Denis Varak, Big Bear City, CA (US)

(72) Inventors: Paul Grabill, Poway, CA (US); Denis Varak, Big Bear City, CA (US)

(21) Appl. No.: 14/845,215

(22) Filed: Sep. 3, 2015

(51) Int. Cl. G01N 29/46; G01P 3/00

(52) U.S. Cl. CPC G01N 29/46; G01P 3/00; G01N 2291/0289

(57) ABSTRACT

A method of monitoring and balancing rotary machinery utilizing bus-based smart vibration sensors with dedicated tachometer signals fed, via a wire or wirelessly, to each bus-based smart vibration sensor.

### BACKGROUND OF THE INVENTION

The invention generally relates to rotating machinery and more particularly to a method and apparatus for using a bus-based smart vibration sensor in conjunction with a composite tachometer.

Vibration forces can result in failure or inefficient operation of rotating machinery. To avoid such pitfalls, techniques and equipment have been developed to monitor and indicate when faults such as imbalance, bearing wear, gear wear, and other such faults are present. Reliable vibration monitoring systems typically begin with an accelerometer. This device is attached to the machine and creates an electrical output signal that is an analog representation of the vibration. The analog signal is typically a complex waveform with all the frequencies of each vibrating component mixed together.

To aid in the decoding of this complicated vibration signal, a tachometer is usually used. The tachometer signal is generated using magnetic, optical, and various speed-sensing techniques. It is the tachometer signal that is used to match the machine's rotational speeds with the vibration that has been measured.

Traditional vibration monitoring systems employ a central data collection system which is connected to the tachometers and accelerometers using a single wire connected to each tachometer and accelerometer as shown in FIG. 1. The typical data collection device digitizes raw analog vibration signals as well as the tachometer signal. Signal processing methods are used to enhance the vibrations that are synchronous with the tachometer. Also, the tachometer data is presented to the users along with the vibration data to aid in pinpointing the vibration source.

The problem with these traditional systems is that they use a central data collection device with limited capacity such that the device cannot continuously measure the vibration from all the connected sensors continuously. If a system has many channels such as 24 or more, the system will typically have to multiplex (mux) or share input lines in order to keep hardware cost down. These 24 inputs are usually connected to only 4 to 6 actual Analog-to-Digital converters. So in order to collect all the inputs, the system may measure up to 6 sensors at a time until all 24 connected sensors have been collected. This process degrades the diagnostic processing capabilities and also slows down the performance of the system, delaying the time until the next series of acquisitions can be acquired. As an alternative, if 24 Analog-to-Digital converters are used in lieu of a mux arrangement, then the expense and size of the central data collection device is often too costly and requires too much mounting volume, particularly in applications where the circuitry is imbedded.

A new and exciting development has recently occurred in the vibration monitoring equipment with the introduction of bus-based smart vibration sensors. These advanced sensors are just now becoming available making the central data collection device unnecessary. These vibration sensors are now “smart” and can process the vibration data internally. Without the central data processor, each smart sensor can be processing and calculating vibration features continuously, negating the need of mux arrangements. The dense analog data that typically consumes large bandwidths now becomes sparse—but significant—digital data and is transmitted down a common data bus. FIG. 2 shows this bus-based smart vibration monitoring architecture.

The data bus for these new sensors is typically a serial communications protocol with throughputs as high as 1 MBit/s. They are a “democratic network” i.e., having no master/slave relationship. Each sensor has its own processor, thus, distributing the processing load across the network and offering redundancy reducing the possibility of failures.

The bus architecture of the prior art offers extremely low probability of undetected data corruption; however, it allows for collisions where lower priority messages need to be sent multiple times when interfering with higher priority messages. This is very problematic for the high frequency tachometer data that is needed in the vibration signal processing. The possibility for collisions and indeterminate timing, coupled with the slow speed of the bus, pose serious problems for putting the tachometer data on the vibration sensor bus. Accordingly, a method is needed to incorporate tachometer signals with bus-based smart vibration sensors.

### SUMMARY OF INVENTION

The present invention provides for a method and apparatus for measuring vibration with a bus-based smart vibration sensor along with a tachometer. For example, the present invention will provide for a system having many independent smart vibration sensors that are each processing the vibration data inside the sensor and having the ability to integrate and utilize the tachometer data for machinery fault detection. This system does not require a central data processing unit and each sensor is processing the data continuously.

The present invention uses a new and dedicated tachometer bus to send high frequency tachometer data to each of the bus-based smart vibration sensors. FIG. 3 shows the new tachometer bus and how it is attached to each of the bus-based smart vibration sensors.

Further, the present invention can more precisely process the vibration data because the tachometer data is sent directly to the bus-based smart vibration sensor without danger of collisions with other data on the bus.

An important vibration signal process using the tachometer involves a process called Time Synchronous Averaging (TSA). For this process to work, each revolution of a gear or shaft of interest must be marked accurately in the vibration data stream. A high degree of accuracy is needed marking the beginning and end of each revolution or the averaging process will be degraded significantly and underestimate the magnitude of the resultant signal. The present invention allows for this accuracy and thus allows for the TSA process to be performed inside the bus-based smart vibration sensor.

Specifically the tachometer signal that is created on this new dedicated tachometer bus is a specially designed signal that not only includes one gear or shaft, but integrates the output of many gears and shafts. The geometry of the machine being monitored is usually fixed such as one gear rotates with a known and fixed relationship to the tachometer. For example, a tachometer will be measuring a gear speed and the other gears that mesh with the tachometer gear have known teeth that mesh so the speeds of the other shafts are known. With this a-priori knowledge, pseudo tachometer signals can be created that are simultaneously broadcast over the new tachometer bus so that each vibration sensor can use one or many of the available tachometer signals on the tachometer bus.

### BRIEF DESCRIPTION OF THE DRAWINGS

The present invention will now be described in more detail with reference to preferred embodiments of the invention, given only by way of example, and illustrated in the accompanying drawings which:

FIG. 1 is a schematic depiction of a typical traditional vibration monitoring system architecture;

FIG. 2 is a schematic representation of a bus-based vibration monitoring system where the vibration data is processed inside each vibration sensor;

FIG. 3 is a schematic representation of a bus-based vibration monitoring system utilizing the new tachometer bus with the tachometer signals wired directly to each vibration sensor;

FIG. 4 is a table of the common mechanical faults that result in vibrations that can be detected and identified through spectrum analysis;

FIG. 5A is a spectrum plot of vibration where faults from a bearing with an inner race fault are identified;

FIG. 5B is a spectrum plot of vibration where faults from a bearing with an outer race fault are identified;

FIG. 6 is a schematic diagram of a bus-based smart vibration sensor;

FIG. 7 is a schematic representation of the flow diagram depicting how a Condition Indicator is processed inside the bus-based smart vibration sensor;

FIG. 8 is a plot of a typical raw tachometer signal that is measured from a rotating machine;

FIG. 9 is a schematic representation of the Time Synchronous Averaging Process;

FIG. 10A is a plot of a vibration signal;

FIG. 10B is a resolved data set following a Fourier transform of the FIG. 10A signal;

FIG. 11 schematic perspective of an example gear train layout from a complicated helicopter drive train;

FIG. 12 is a schematic representation of the process of creating a pseudo tachometer signal from a known gear ratio from meshing gears;

FIG. 13 is a schematic depiction of a block diagram of the components in the Composite Tachometer Bus Signal Generator;

FIG. 14 is a parallel plot of raw tachometer signals showing how the event is defined;

FIG. 15 is a schematic representation of the process of converting the events into the sinusoidal signals;

FIG. 16 is a plot depicting the addition of sine pulses into a single signal;

FIG. 17 is a schematic representation of a waterfall plot of the composite signal;

FIG. 18 is a schematic representation of a waterfall plot of Composite tachometer signal using the frequency modulation technique;

FIG. 19A is a schematic representation of the diagram of a digital implementation of the composite tachometer signal; and,

FIG. 19B depicts the summing of the multiple tach signals into the composite signal.

### DETAILED DESCRIPTION

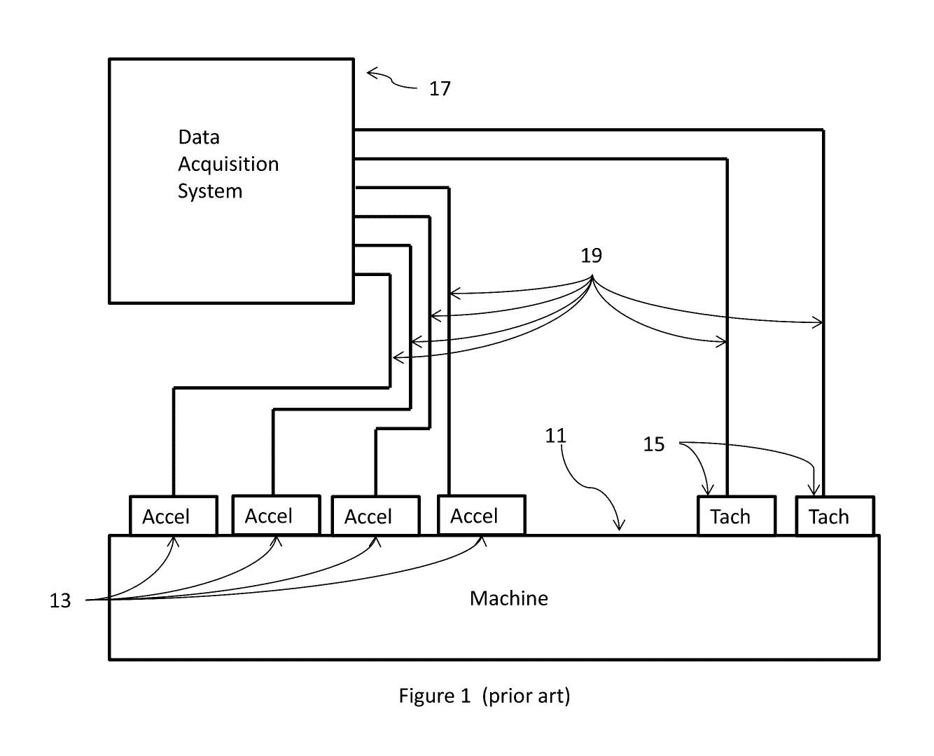

FIG. 1 is a schematic depiction of a typical traditional vibration monitoring system architecture where the output from machine 11 accelerometers 13 and tachometers 15 are wired directly to a central data acquisition system 17. It will be appreciated there may be as many accelerometers 13 and tachometers 15 as needed to gather the relevant data. The signals in the wires 19 are typically analog voltages which are processed in the central data acquisition system 17.

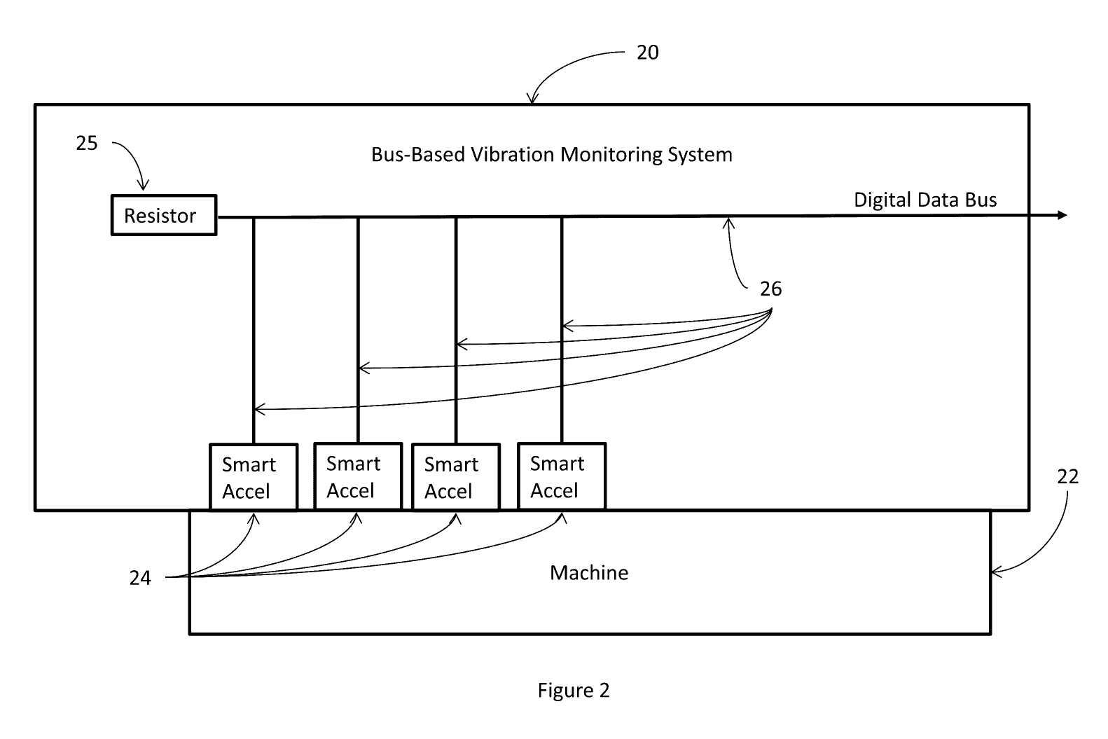

FIG. 2 is a schematic representation of a bus-based vibration monitoring system 20 of the present invention where the vibration data acquired from machine 22 is processed inside each vibration sensor 24. System 20 includes a 120 ohm bus resistor 25. The signals in the wires 26 are digital which includes vibration features related to any mechanical faults residing in the machine 22 at the time the signals are acquired.

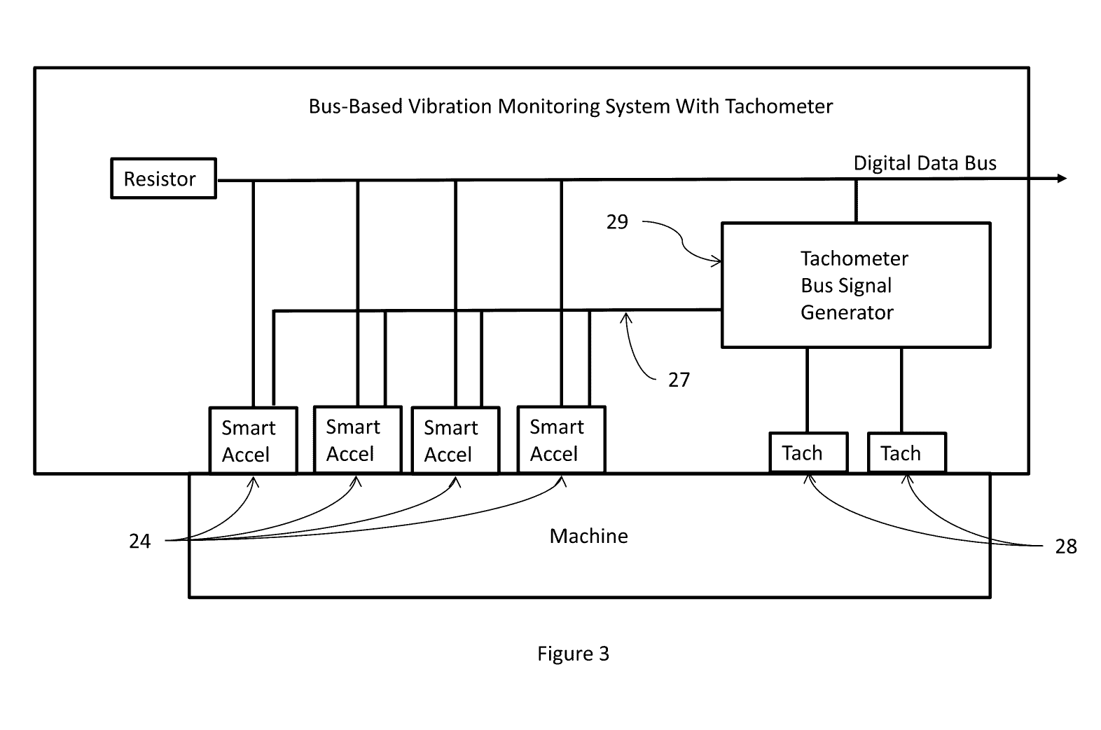

FIG. 3 shows how the signals from tachometers 28 are conditioned by bus-based signal conditioner 29 and used to create a bus-based vibration monitoring system in which the signals from tachometer bus 29 are transmitted to each vibration sensor 24. This may be done through wires 27 or, in some embodiments, wirelessly.

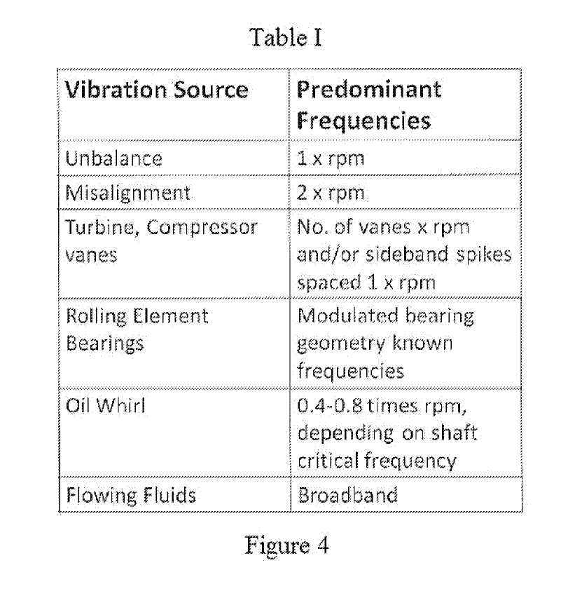

FIG. 4 comprises Table I showing the common mechanical faults that result in vibrations that can be detected and identified through spectrum analysis.

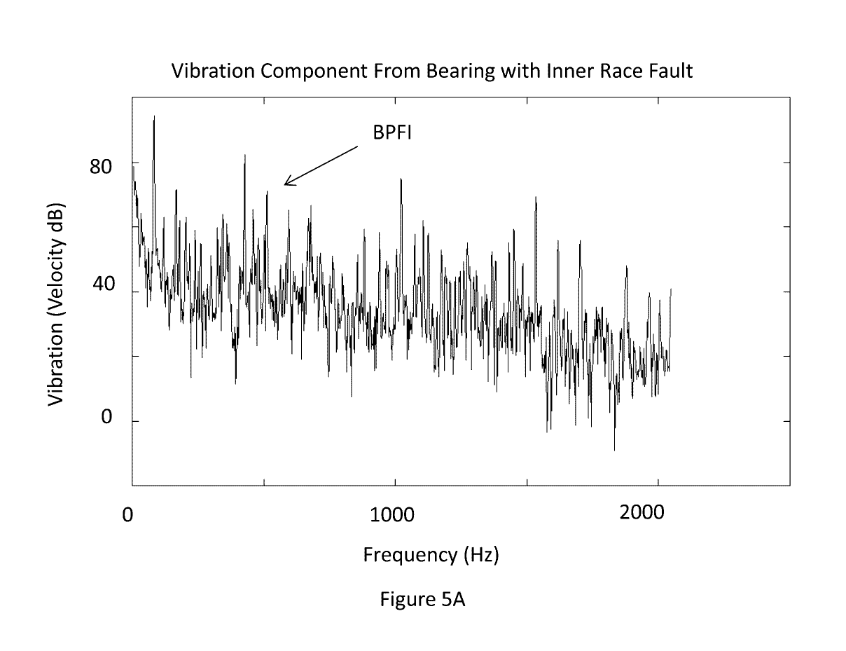

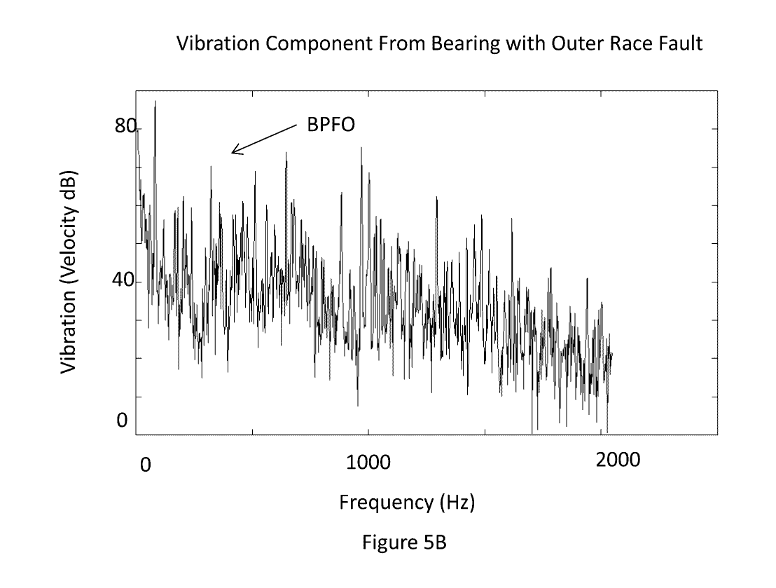

FIG. 5A represents a spectrum plot of vibration where faults from a bearing with an inner race fault is identified and an FIG. 5B an outer race fault is identified. BPFI is an indication of Ball Pass Frequency Inner Race and BPFO is an indication of Ball Pass Frequency Outer Race.

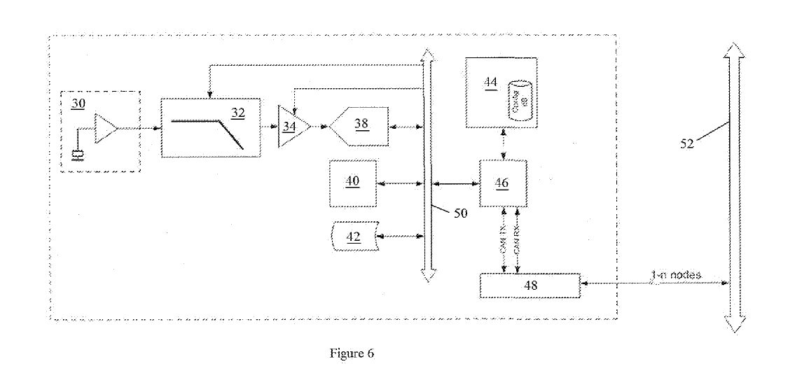

FIG. 6 represents the system diagram of a bused based smart vibration sensor where a Piezo based transducer 30 is used to detect vibration along a single axis. An analog anti-alias filter 32 removes vibration data above the desired bandwidth. A programmable gain (auto-gain) circuit 34 amplifies the vibration signal to suitably fit into analog to digital converter range. An analog-to-digital converter 38 samples the raw vibration data. The DSP MCU 40 is a microcontroller that performs digital signal processing. This is where the spectral data and Condition Indicators are calculated. Static RAM 42 is used for volatile data storage. EEPROM 44 is a non-volatile data storage area for the sensor configuration database and BIT test results. The CAN MCU 46 is a microcontroller that communicates with the CAN Transceiver 48 and passes raw and processed vibration data to the Bus 50 and receives messages from the Bus 50. The CAN Transceiver 48 packages data and communicates with the CAN v2.0b bus 52.

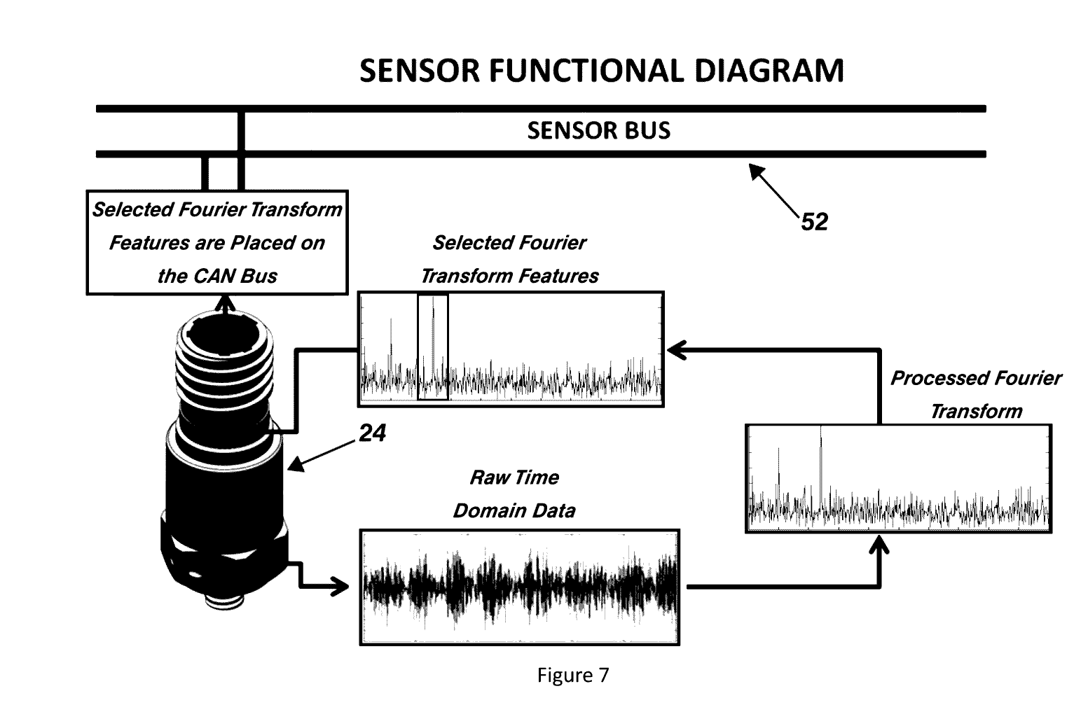

FIG. 7 represents the flow diagram of how a Condition Indicator is processed inside the bus-based smart vibration sensor 24. The bottom plot shows the raw time domain acceleration signal as measured from the internal accelerometer. This data is then processed inside the sensor 24 to create a spectra by use of the Fourier Transform. The spectral data is shown on the right side plot as a result of processing with setup parameters for Averaging, Overlap, and Windowing. This data is then passed to a Condition Indicator algorithm such as a “peak within a band” or peak picker. The figure shows how the peak of the spectral data is calculated from within a preset band. Finally the digital data is shown exiting the sensor on the top to the CAN Bus 52.

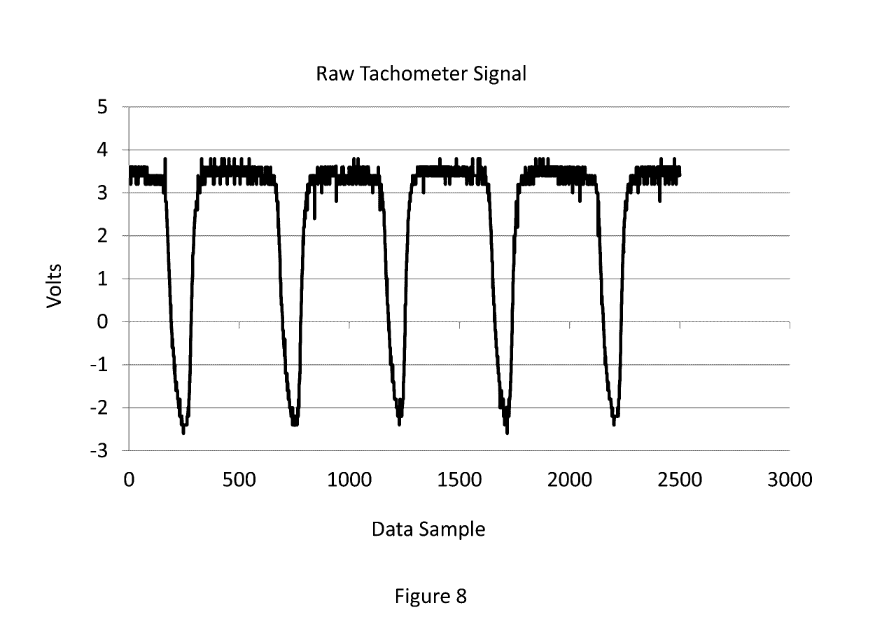

FIG. 8 represents a typical raw tachometer signal that is measured from a rotating machine. The zero crossings from this plot indicate the timing spot needed for the speed calculations and the period for the Time Synchronous Averaging process.

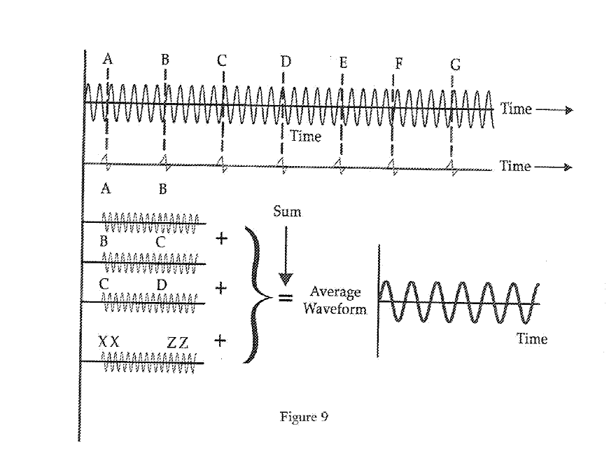

FIG. 9 represents the Time Synchronous Averaging Process. The raw time history data shown at the top of the figure is segmented into revolutions based on the zero crossings from the tachometer signal. Each revolution of the shaft of interest is added to the next such that the constructive nature of synchronous signals add while the destructive nature of non-synchronous signals cancel, resulting in an average waveform that is then used for balancing and gear and shaft fault diagnostics.

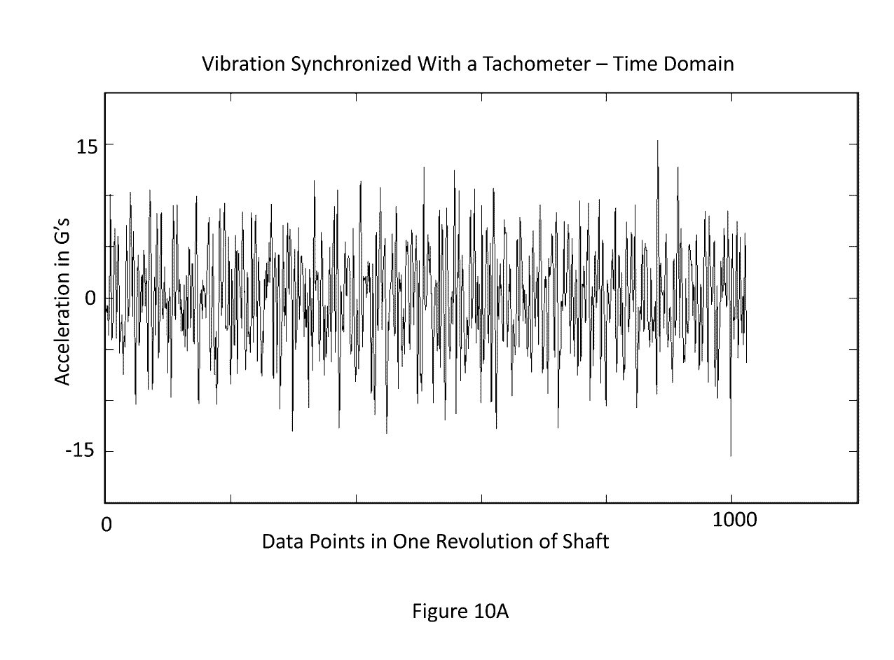

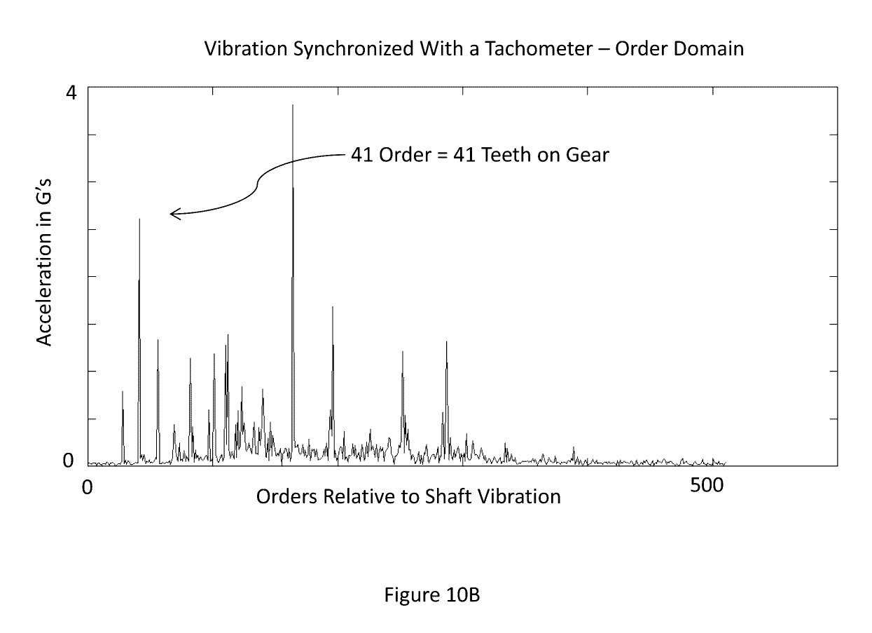

FIG. 10A shows the initial data while FIG. 10B depicts the signal following a Fourier transform of the TSA signal. By doing so, the signal is allowed to go from the time domain to the order domain. Each peak in the order domain plot represents the vibration that is synchronous with the order or base revolution period. So the first order peak (peak in the first bin) is all the vibration that is synchronous with the period of the tachometer assuming the tachometer gives one pulse per revolution of the shaft. A peak in the 41^{st} bin as shown in this plot is the vibration that results in 41 times the base period. For this plot the vibration is from a gear where there are 41 teeth on the gear.

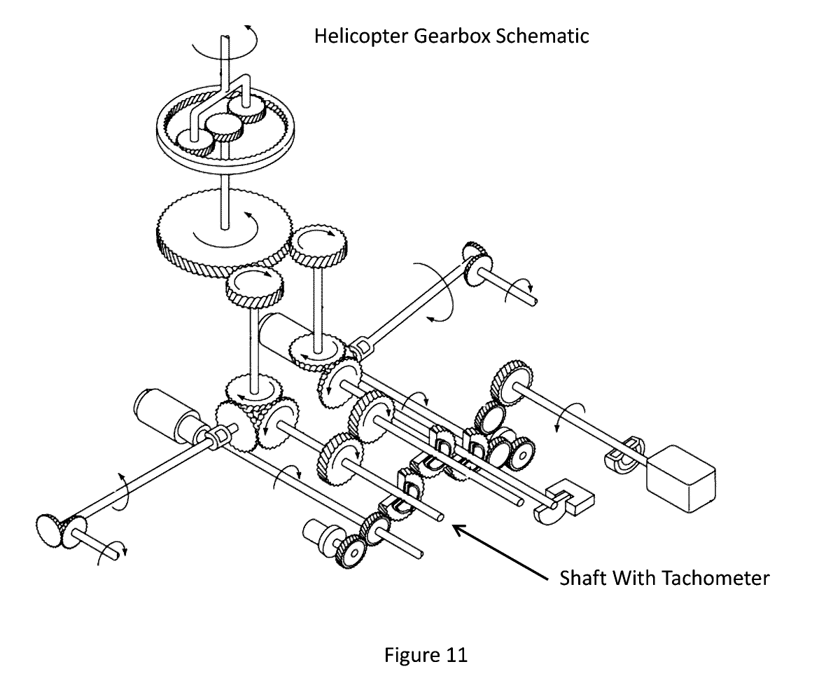

FIG. 11 represents an example gear train layout from a complicated helicopter drive train. Each shaft and gear speed can be found from a tachometer signal simply by multiplying the gear ratios as you reference one shaft speed to the mating gear or shaft. For this example there are 16 shafts and 37 gears where each shaft speed and gear speed can be determined from two tachometers.

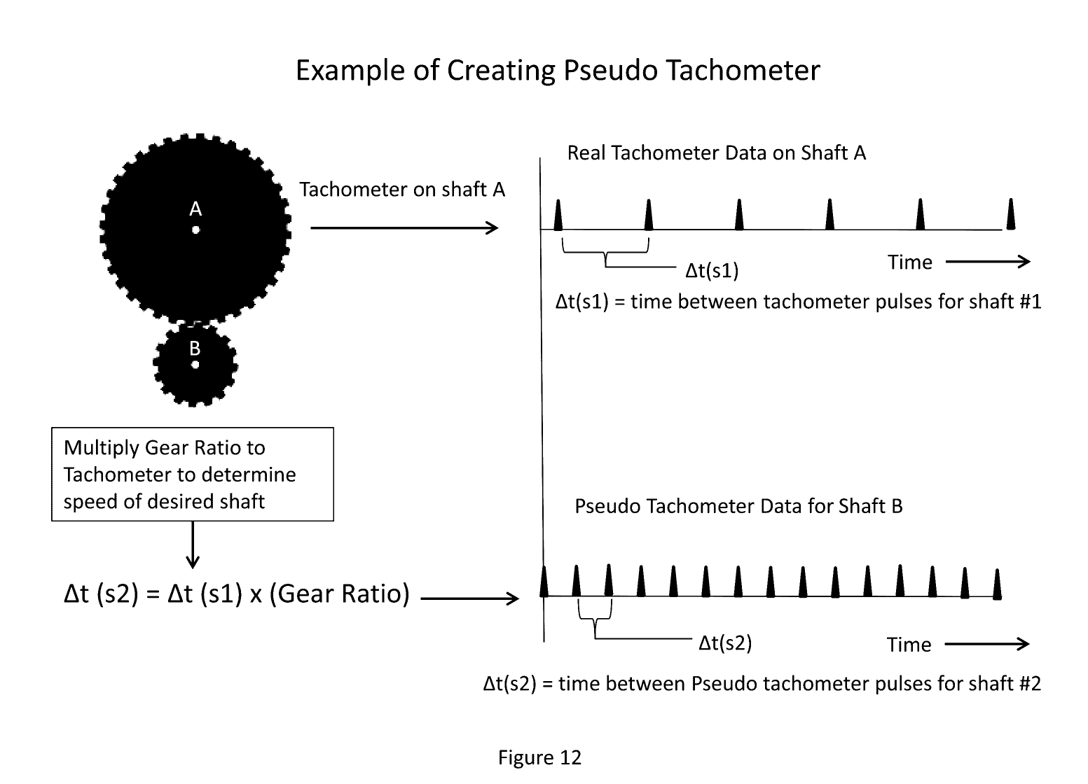

FIG. 12 represents the process of creating a pseudo tachometer signal from a known gear ratio from meshing gears. The pseudo tachometer signal is used for the Time Synchronous Averaging process where the vibration data to be synchronized is not from a shaft associated with the tachometer.

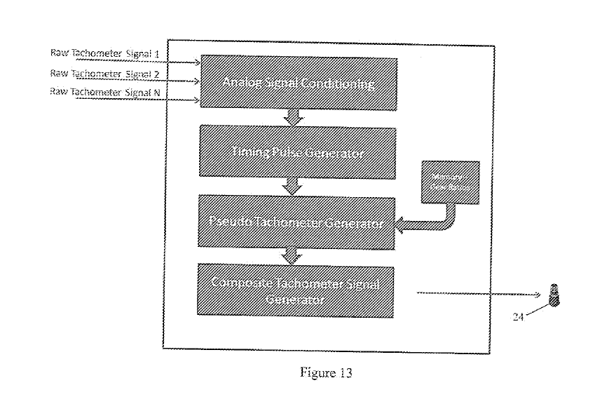

FIG. 13 represents a block diagram of the components in the Composite Tachometer Bus Signal Generator. The tachometer signal interface pre-processes the signal and passes the results to the timing pulse generator. The pseudo tachometer timing pulses are calculated and then the Composite Signal Generator creates the waveform which is broadcast on the Composite Tachometer Bus.

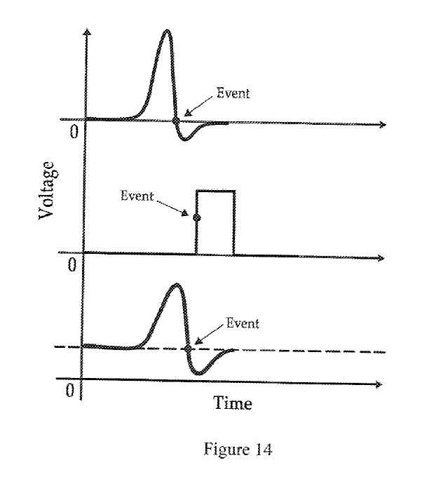

FIG. 14 represents raw tachometer signals and how the event is defined.

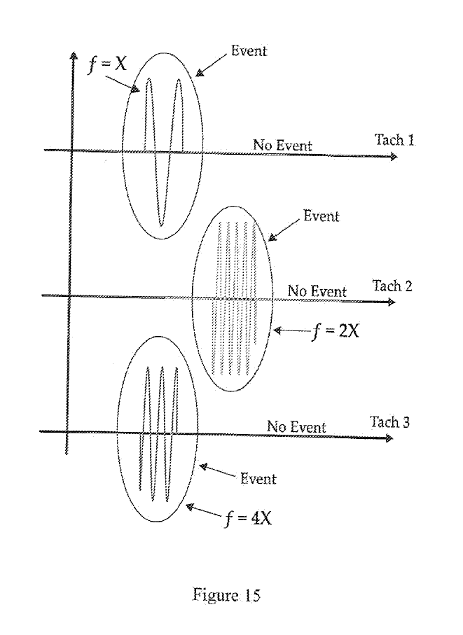

FIG. 15 represents the process of converting the events into the sinusoidal signals.

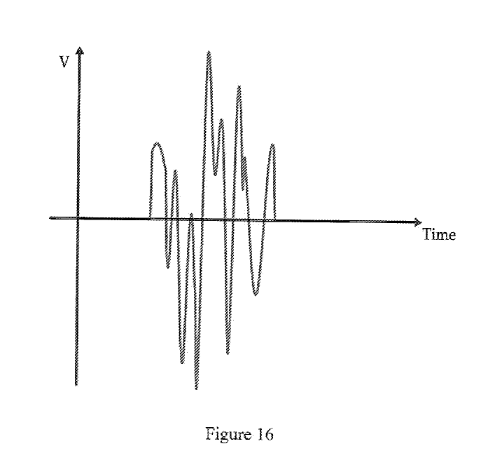

FIG. 16 represents the process of adding sin pulses into one signal

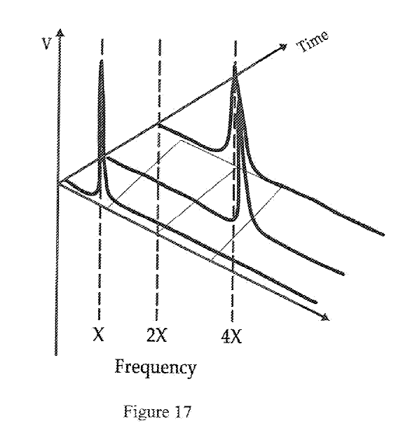

FIG. 17 represents a waterfall plot of the composite signal. The x axis shows the frequency while the z axis shows time and the y axis shows signal amplitude. The timing of the event, which is used by the vibration sensor is accomplished by filtering one frequency and looking for when a tone is present or not present. Each tone is one predefined tachometer or psudo tachometer channel. The tone present or not defines the event.

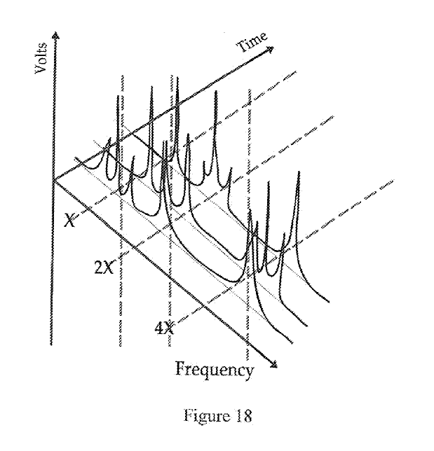

FIG. 18 represents a waterfall plot of Composite tachometer signal using the frequency modulation technique. The x axis shows the frequency while the z axis shows time and the y axis shows signal amplitude. The timing of the event, which is used by the vibration sensor is accomplished by filtering one frequency and looking at the sidebands around a particular tone. Each tone is one predefined tachometer or pseudo tachometer channel. The sidebands define the event.

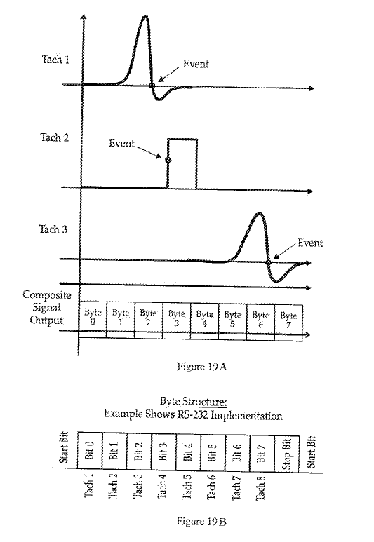

FIG. 19A represents the diagram of a digital implementation of the composite tachometer signal, while FIG. 19B depicts the summing of multiple tach signals to form the composite signal. The event triggers the state of one bit.

1. Details on Vibration Monitoring—Spectrum Analysis

Machinery condition analysis based on vibration monitoring has been performed for many years with significant advances in the instrumentation and signal processing over the years yet hardware designs have been stagnate and still feature a central processing unit. For monitoring condition of rotating machines it is usual to use the method of spectral analysis of the vibration signal. This method has the ability to separate the vibration components of sources which are from different areas or components of the machine.

The use of frequency spectrum analysis has been given its broadest application as a means of predictive maintenance in rotating machinery. Typically the frequency spectrum is measured with a real time analyzer at some regular time interval and compared to previous data. Any change means that there has been a mechanical change in the rotating equipment. Depending on the frequency, the exact component causing the change can often be identified.

In a rolling element bearing, the frequencies generated depend on the geometry of the rolling elements. Element spin frequency, element inner and outer race passing frequency, cage rotating frequency, rotation of a rough spot on an elements inner or outer race, and the sum and difference frequencies or “sideband” frequencies cause a wide variety of spikes to show in the spectrum. FIG. 4 shows how these frequencies are related to common mechanical vibration sources. FIG. 5 shows a representative vibration spectrum from a faulty machine with the fault frequencies identified.

The manual examination and threasholding of vibration spectra can be a tedious and labor intensive task based on the numbers of peaks complexity of the vibration spectra. Automated peak picking and feature extraction techniques have been developed over the past 4 decades resulting in a vast library of algorithms outputting features called Condition Indicators.

2. Details on Condition Indicators

Condition Indicator (CI) algorithms are model-based tools that use a priori knowledge of the machine as a basis for the fault diagnosis. This a priori knowledge includes information about rotational speed, mechanical construction (such as gear ratios and inner and outer race data on bearings), and information on structural vibration or acoustic resonance of the system to be diagnosed. A condition indicator uses some form of measured data as input and produces a single real number as output. This single number can be thresholded, trended, fused or otherwise analyzed to provide an indication of the location and type of fault condition. There is a large body of literature on mechanical signature analysis, [insert reference] which is used to develop the knowledge base for this.

Bearing CI—Diagnostic algorithms designed to detect the onset of rolling-element bearing faults. These techniques use a combination of time and frequency domain processes. Many of these algorithms use signal demodulation or the Hilbert transform to enhance the bearing fault signature.

Engine CI—Diagnostic algorithms designed to detect the faults associated with gas turbine engines. These techniques are designed to find gas turbine faults such as rotor unbalance, rubs, accessory faults, and augmentor faults.

Gear CI—Model-based feature extractors that are founded on the a priori knowledge of gear faults to include meshing faults, spalling, pitting, and heavy wear. The algorithms have been developed [1] to extract the gear fault data from averaged time domain data. Many of the public domain algorithms have been developed at NASA and have been proven over the last 10 years.

General CI—Algorithms that extract information from frequency spectra. These algorithms include spectral peak detectors that can be programmed to select the peak or energy in a band based on frequency ranges or RPM. Many of the basic faults in drive shafts such as unbalance and misalignment can be detected with these algorithms.

3. Details on CAN Bus and Smart Sensors

Controller Area Network (CAN) data bus is a serial communications protocol that supports distributed real-time control with a high level of security. Introduced in the 1980s by Robert Bosch GmbH, the CAN bus was first installed in Mercedes-Benz cars. To improve safety and comfort, many electronic control units (ECU), such as anti-lock braking, engine management, traction control, air conditioning control, central door locking and powered seat and minor controls, were added in automobiles. To interconnect these ECUs and reduce large wiring looms, the CAN bus was implemented.

It is capable of working reliably, even in harsh environments. Because of its success in automobiles, trucks, and heavy equipment, CAN bus technology has attracted the attention of manufacturers in other industries, including process control, textiles and medical instruments. CAN bus operates at data rates of up to 1 Mb/sec for cable lengths less than 40 meters. The data signal is normally transmitted on a twisted pair of wires.

Vibration sensors (unlike temperature, pressure, inertia, load, and other slowly changing physical measurement factors) produce incredible volumes of dynamic data. Streaming dynamic vibration data down a bus is not possible given the limitations of bus processing speeds and embedded memory storage. Dynamic vibration sensors capable of sophisticated machinery diagnostic functions traditionally have remained all-analog and have not transitioned to bus communication.

New technologies in smaller micro controllers now have opened the door for a bus-based smart vibration sensor. This revolution now offer simpler wiring schemes, shorter sensor cable runs, and user-configurable software to optimize each monitoring location for the best possible results. The bus-based smart vibration sensor can be configured to operate under a variety of bus protocols and is not limited just to CAN bus (for example CAN, ARINC 429, etc.) may be used for ease of integration within existing systems. The new bus-based smart vibration sensor is a flexible, scalable platform on which to host diagnostic software in a bussed environment. The sensors are small and robust, capable of withstanding demanding industrial environments providing years of dependable operation.

4. Details on how Smart Sensors calculate CIs in the Sensor.

The bus-based smart vibration sensor offers the ability to collect vibration data, process spectral data and calculate Condition Indicators within the sensor itself without the need of an external data processor used with traditional ICP or IEPE type accelerometers. The sensor can then transmit the vibration and Condition Indicators over a bus such as CAN bus interface using a network protocol. FIG. 6 shows the architecture of a bus-based smart vibration sensor.

5. Details on Tachometers

Tachometers are sensors used to measure the position and speed of rotating machinery. They can be magnetic or optical and produce an analog signal as shown in FIG. 8. If there is just one interrupter installed on the shaft, or just one reflective mark on the shaft, then the time period between pulses is the inverse of the frequency of the rotation of the shaft measured in Hertz. If there are more than one pulse per revolutions such as to be found when the magnetic sensor is monitoring the teeth on a gear, then the frequency of the tachometer measurement is N times the frequency of the shaft, whereby N is the number of teeth.

The shaft frequency measurements as calculated from the tachometer signal is a critical part of the vibration based machinery diagnostics. The frequency of the tachometer can be used by the Condition Indicator algorithms to find peaks in the spectra that are related to the faults as shown in FIG. 4.

6. Details on Time Synchronous Averaging

The technique of Time Synchronous Averaging (TSA) involves processing the vibration data in the time domain to suppress uncorrelated noise and attenuate the non-synchronous vibration. This translates into an improvement in signal-to-noise ratio (SNR). The TSA process involves partitioning the vibration signal into individual segments corresponding to the period of each gear or shaft. Averaging is performed while still in the time domain where each revolution is simply added to the next. The end result waveform will contain vibrations that are produced by components that are synchronous with the period of the revolution and their harmonics. FIG. 9 shows the process of the TSA and the resultant wave form.

When the final averaged waveform is put through a Fourier transform the x axis becomes orders where the first order is the fundamental frequency of the period of the averaging block. FIG. 10 shows the order domain plot that is a result of the Fourier transform of a TSA waveform.

The peaks from this resultant process of the TSA are very useful for machinery diagnostics. The first order peak, both amplitude and phase, are the inputs needed for balancing of rotors and shafts. The gear tooth mesh tones show up at integer multipliers of the number of teeth on each gear.

The TSA is well suited for complicated machinery and gearboxes where numerous vibration sources are generated in relatively close proximity to one another. The interactions of multiple gear mesh and bearing vibration frequencies in a very dynamic environment can make fault detection nearly impossible to achieve from analysis of spectral data.

The difficulty in producing the TSA is usually related to the accuracy and timing of the tachometer signal. As mentioned earlier the tachometer signal is used to segment the vibration data into revolutions of the shaft. If the machine was running at a constant frequency and the tachometer was slow, this process is not hard because the beginning and end points of each revolution can be found with little error. However, if the machine is changing its speed even slightly, and the speed of the gear or shaft of interest is fast, then the beginning and end points of each revolution become more difficult to find. The errors associated with finding the end points of the vibration data segment add for each average and the “jitter” caused from an inaccurate timing and segmentation results in a degraded and sometimes unusable TSA which if used will generate incorrect results.

7. Details on Pseudo Tachometers

Many times the tachometer is not mounted on the shaft or gear of interest. In applications such as helicopter gearboxes and other complex vehicles and machines, the tachometer is measuring an accessible gear or shaft. The rotational frequencies of all other gears and shafts are known simply by the kinematics of the drive train. FIG. 11 shows a typical complicated helicopter gearbox and the number of teeth on the gears. From this information and from the tachometer signal “pseudo” tachometer signals can be generated and used for the TSA process. FIG. 12 shows how the “pseudo” tachometer signal is generated and applied to the vibration signal for the TSA process.

8. Details on Why the Tachometer Data Cannot be Put on the Accelerometer Bus

One approach to providing the tachometer data to the bus-based smart vibration sensor would be to simply put the timing pulses from the tachometer onto the vibration sensor bus. This approach has many flaws which makes it unusable. First, the tachometer data can be high speed with frequencies as high as 3500 Hz on some rotorcraft and other complex machines. If each time a timing pulse was detected and was broadcast on the vibration sensor data bus, the bus would overload with data. The second reason this approach is flawed is that the bus is non causal with unknown delays occurring with data collisions. This unknown nature of the actual timing of the tachometer pulse would result in gross jitters and improper segmentation of the vibration data. For these reasons and for the need of the TSA process for vibration monitoring, the present invention of the tachometer bus was created.

9. Details on Why Using Zero Crossing Time Method is Inferior

Some methods have been proposed to inserting timing data on the sensor bus as a means for tachometer synchronization (Reference Beck). This approach uses zero crossing times which are calculated in a tachometer sensor and then broadcast over the sensor bus to each vibration sensor. This is fundamentally different than the method proposed in the present invention in that:
The zero crossing time method requires the tachometer data to be post processed and inserted into the vibration data after the vibration data is collected. This is a multi-step and computationally intensive process. This slow process makes the real time and continuous processing of time synchronous data impossible. It is always a two step process. First measure the zero crossings and then broadcast that data over the bus for the sensor to post process the data it has already collected. With the proposed invention, because of the dedicated composite tachometer bus, the sensors can synchronize in real time and can continuously output the vibration features. A real-time and continuous output of the time synchronous averaged data is novel and significant diagnostic improvement in the state of the art of vibration monitoring.
The zero crossing time method requires that very accurate timing data be synchronized across each sensor on the bus. This means that each sensor on the bus needs a clock and the clocks need to be synchronized. With the proposed invention of the composite tachometer bus, there is no more a requirement for the sensors to be clocked and to be synchronized. This will reduce the complexity and potential bad data being collected by the system.

10. Details on Composite Tachometer Bus

The present invention of the composite tachometer bus for the bus-based smart vibration sensor involves four main components as shown in FIG. 13. (1) The tachometer signal interface (2) the tachometer timing pulse generator (3) the pseudo tachometer timing pulse generator and (4) The Composite Signal Generator.

The main challenge to overcome in any application that involves synchronous measurements involving a tachometer is the requirement that all of the tachometer signals have to be available immediately to all the nodes performing the measurements. The typical application requires a separate wire for each tachometer signal which makes it very cumbersome. The present invention allows multiple tachometer signals and psudo tachometer signals on the same wire with a method to make available to multiple measurement nodes access to one or more of the individual tachometer or psudo tachometer signal.

FIG. 14 shows some examples of raw tachometer signals shown in FIG. 13.

Those signals are sampled on the input of the Tachometer Bus signal Generator looking for predefined “Event”. Pre-defined event is considered to represent a gear passing the 0 degrees point during each revolution. Once the “Event” is detected by the device, The Timing Pulse generator module converts the “Events” into the sin waves shown in FIG. 15. The frequency of the sin wave is specific to the Tachometer input. The Pseudo Tach Generator will generate additional pseudo events based on the preprogrammed gear ratios. The Composite Tachometer Signal Generator will add all of those signals into one using a summing type amplifier. The resultant wave will look like FIG. 16. The waterfall plot of the resultant signal is shown in FIG. 17. The basic idea is that the peak at a certain predefined frequency appears only when the “Event” is detected. This technique allows the signals from different independent tachometers reside on the same wire. A measurement node can be preprogrammed to look for a specific frequency which would designate the tachometer or a pseudo tachometer that relates to the shaft of interest. Applying a bandpass filter to the composite tachometer signal a measurement node can filter out all the unnecessary information and monitor a particular tachometer of interest. This technique is using amplitude modulation to convey “on/off” state of the tachometer to the remote location using the carrier frequency as destination address.

The same idea can be accomplished using frequency modulation technique. In that case the resultant waterfall graph shall look like FIG. 18.

In case of frequency modulation technique, the presence of the sidebands around the carrier frequency would indicate the presence of the “Event” in this particular moment in time.

The digital implementation is also possible. A constant serial transaction of data (any serial method could be used—RS232, CAN, USB, ect.) has certain number of bits (for the sake of this example: 8 bits). Each bit represents a tachometer input. In that case, the operation would look like in FIG. 19.

Each bit in the serial transaction is associated with a tachometer number, so in the example shown in FIG. 19 Byte 0 is equal to 0, Byte 1 equal to 128 (10000000), Byte 2 equal to 0, Byte 3 equal to 0, Byte 4 equal to 64 (0100000), Byte 5 and Byte 6 equal to 0 and Byte 7 equal to 32 (00100000).

The digital method introduces the greatest timing error, however considering the discrete nature of the sampling process and providing that the serial transaction is taking place at much greater speed than the sampling circuitry there are still practical implementations for this method to work.

The digital method is also the easiest to implement as the circuitry design is much simpler compared to the other methods.

Various changes, alternatives, and modifications will become apparent to a person of ordinary skill in the art after a reading of the foregoing specification. It is intended that all such changes, alternatives, and modifications as fall within the scope of the appended claims be considered part of the present invention.

We claim:

1. A method for machinery monitoring and balancing comprising the steps of i) developing a composite tachometer signal, ii) attaching a plurality of bus-based smart vibration sensors to said machinery, and iii) feeding a dedicated tachometer signal to at least one of said bus-based smart vibration sensor.

2. The method of machinery monitoring and balancing of claim 1 wherein said dedicated tachometer signal is transmitted to at least one of said bus-based smart vibration signal by a wire.

3. The method of machinery monitoring and balancing of claim 1 wherein said dedicated tachometer signal is transmitted to at least one of said bus-based smart vibration signal by a wireless connection.

4. The method for machinery monitoring of and balancing claim 1 wherein said composite tachometer signal sums resultant shaft speeds from many associated shafts, said composite signal being simultaneously broadcast to at least one of of said bus-based smart vibration sensors.

5. The method for machinery monitoring and balancing of claim 4 further comprising the step of providing setup information in the memory of the tachometer bus signal processing device.

6. The method for machinery monitoring and balancing of claim 4 further comprising the step of creating the composite tachometer signal using a summing of tachometer signals.

7. The method for machinery monitoring and balancing of claim 4 further comprising the step of creating the composite tachometer signal using amplitude modulation.

8. The method for machinery monitoring and balancing of claim 4 creating the composite tachometer signal using frequency modulation.

9. The method for machinery monitoring and balancing of claim 4 creating the composite tachometer signal using a digital summing.

10. The method for machinery monitoring and balancing of claim 1 wherein said method step of feeding a dedicated tachometer signal comprising feeding a dedicated tachometer signal to each said bus-based smart vibration sensor.

11. A method for synchronizing a tachometer with a bus-based smart vibration sensor using the tachometer signal embedded in one of a group selected from a power line and a return line.

12. A method for locating tachometer signal processing near the rotational source while simultaneously allowing tachometer processing to be distributed across multiple processing locations utilizing a single cable-run presently used by the smart bus-based vibration sensor as a source of power, tachometer synchronizing signal and bus-based real time component speed output.
